(19) United States
(12) Patent Application Publication
(10) Pub. No.: US 2008/0028053 A1
(43) Pub. Date: Jan. 31, 2008

(54) Method and system for a wake on LAN (WOL) computer system startup process

(76) Inventors: Benjamin Kelley, Austin, TX (US); James E. Dailey, Round Rock, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/494,185

(22) Filed: Jul. 27, 2006

(51) Int. Cl. G06F 15/177

(52) U.S. Cl. 709/222; 709/220

(57) ABSTRACT

Methods and systems are disclosed for a Wake On LAN (WOL) computer system startup process that receives WOL instructions and control information for modifying the computer system startup process. The control information may be, for example, a password, or instructions to enter the system by bypassing a password. The password can be a system password or a hard drive password. The control information may be, for example, an instruction to boot up from another device, such as a network server. The control information may also be an instruction to disable Alert Standard Format (ASF) reporting. Thus, the boot up procedure can be reconfigured to a modified boot up sequence based upon control information provided as part of the WOL process.

### TECHNICAL FIELD OF THE INVENTION

This invention relates to a method for a Wake On LAN (WOL) computer system startup process, and particularly to setting up a WOL process to send WOL instructions and control information for modifying the computer system startup process.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems provide Wake On LAN (WOL) functionality. WOL is a PC computer network standard that allows a “sleeping” computer to be brought up to full power remotely, over a network. WOL is used to turn on or wake up a system remotely. To use WOL functionality, a system may have a network card with a chipset that supports this feature. One advantageous use of WOL functionality is to allow IT personnel to manage and deploy software without a user being present. For example, System Management Server (SMS) can be run at night to deploy new virus updates or software. Remote management of low level hardware via BIOS can be cumbersome since WOL is limited to asserting a power management event (PME) and passing control over to the BIOS for boot or resume. Many current systems have PME functions built into their I/O chips. A PME event can be generated, for example, by pressing any key of the keyboard, or moving a mouse connected to the system. The PME event can wake up a system from soft off, or resume a system on standby or in suspend mode. However, if the system has a boot password, the BIOS may halt the management process by waiting for the boot password to be entered. Currently, no method exists to send command codes to embedded firmware remotely as part of WOL.

### SUMMARY OF THE INVENTION

The present invention provides systems and methods for a Wake ON LAN (WOL) computer system startup process that receives one or more WOL instructions and control information for modifying the computer system startup process. The control information can be, for example, a system or hard drive password, or can be instructions to wake up the system by bypassing a password requirement. Other types control information, however, may also be utilized. The control information may alternatively be an instruction to boot up from another device, such as a network server. Thus the control information may allow the boot up procedure to be reconfigured to modify the boot up sequence. The control information may alternatively be an instruction to disable Alert Standard Format (ASF) reporting. The techniques described herein may further be advantageous to a wide range of other types of control information. The system control information may be received by the information handling system's network interface and may be stored within such interface and/or may be sent to a memory device.

In one embodiment, a method for performing a Wake On LAN (WOL) process for a network connected computer system is provided. The method may comprise receiving one or more WOL instructions and receiving control information as part of the WOL startup process for modifying the computer system startup process. As described below, other features and variations can be implemented, if desired, and a related method can be utilized, as well.

In another embodiment, a method of controlling an information handling system is provided. The method may comprise providing Wake On LAN (WOL) functionality within the information handling system, receiving WOL data; and receiving a control signal in conjunction with the WOL data so as to cause a modified information handling system startup in response to the WOL data. As described below, other features and variations can be implemented, if desired, and a related method can be utilized, as well.

In yet another embodiment, an information handling system for implementing a Wake On LAN (WOL) computer system startup process is provided. The system may comprise a network interface that is configured to receive one or more WOL instructions and system BIOS that is configured to utilize control information provided as part of the WOL instructions for modifying the information handling system startup process. As described below, other features and variations can be implemented, if desired, and a related system can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram of an information handling system connected to a network via a network interface card (NIC); and

FIG. 2 is a flowchart illustrating exemplary steps for Wake ON LAN (WOL) system startup process by sending WOL control information for modifying the computer system startup process.

### DETAILED DESCRIPTION OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

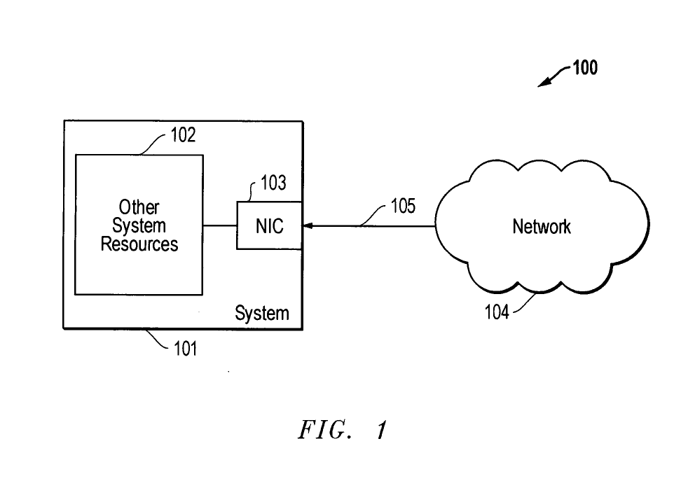

The techniques described herein provide systems and methods for a Wake ON LAN (WOL) information handling system startup process that receives one or more WOL instructions and control information for modifying the system startup process. FIG. 1 shows a general block diagram of an information handling system 101 that is connected to a network 104 via a network 104 interface card (NIC) 103 and a network connection 105. The network interface card 103 may be coupled to other system resources 102, such as for example system buses, processors, memory, interface devices, software, and the like. Though the illustrative technique for connecting to a network is described herein as a network interface card, it will be recognized that any of a wide range of connection techniques may be utilized and that the techniques described herein at not limited to any such particular connection.

The information handling system 101 receives one or more WOL instructions and receives control information for modifying the system startup process. In one exemplary technique, the control information may be a system or hard drive password, or can be instructions to startup the system by bypassing a password. Thus, even though the system or the system's hard drive may be password protected, WOL techniques may still be utilized as the control information provided as part of the WOL process allows for the system to be started up despite the existence of such password protections. The techniques described herein are also useful, however, for providing other types of control information. The control information may alternatively be an instruction to boot up from another device, such as booting up from a network server or booting from some alternative drive. Thus the control information may allow the boot up procedure to be reconfigured to modify the boot up sequence. The control information may alternatively be an instruction to disable Alert Standard Format (ASF) reporting. It will be recognized that the techniques described herein may further be advantageous to a wide range of other types of control information and that the techniques described herein are not limited to the particularly type of control information provided as part of the WOL process. The system control information provided as part of the WOL process may be stored in the network interface card (NIC) 103 and/or can be stored in a different system memory resource.

Thus as compared to the prior art, an enhanced WOL process is provided in which the WOL process can selectively trigger desired behaviors in the system's BIOS. For example, the WOL instructions or packets may embed system control commands. When the WOL packets are received, the receiving NIC may decode the embedded control commands and place the commands in the NIC's PCI Configuration Space. The NIC may then assert a PME signal which passes control to the system BIOS. A system configure to utilized the techniques described herein may have a BIOS that is set to examine the PCI Configuration Space for such embedded commands. Upon detection of such embedded WOL control commands, the BIOS may then carry out the action embedded in the command. Thus for example, the boot device may be selected. Alternatively, the embedded command may include a boot password that is provided so that the BIOS will continue booting and not stop at a boot password prompt. Alternatively, other control commands or combinations of control commands may be obtained as the techniques described herein are not limited to particular commands. Thus, for example, the standard boot code may include instructions to check one or more flags that may be set by the WOL process. When the WOL process sets that flag then the actions associated with that flag may occur. In another example, setting a particular flag may indicate that a boot password is skipped. Alternatively, setting a particular flag may indicated that a password should be obtained from the NIC. In this manner any of the control actions included in the WOL process may be executed.

The control information described herein that may be provided as part of the WOL process (such as for example the system password, hard disk password, boot up sequence, ASF control or other control instructions) may be distinguished as system control information. Such information provides additional system control beyond merely the WOL instructions. Thus, the control information is distinguishable from a WOL password which a NIC may be configured to be required to receive prior to accepting a WOL instruction.

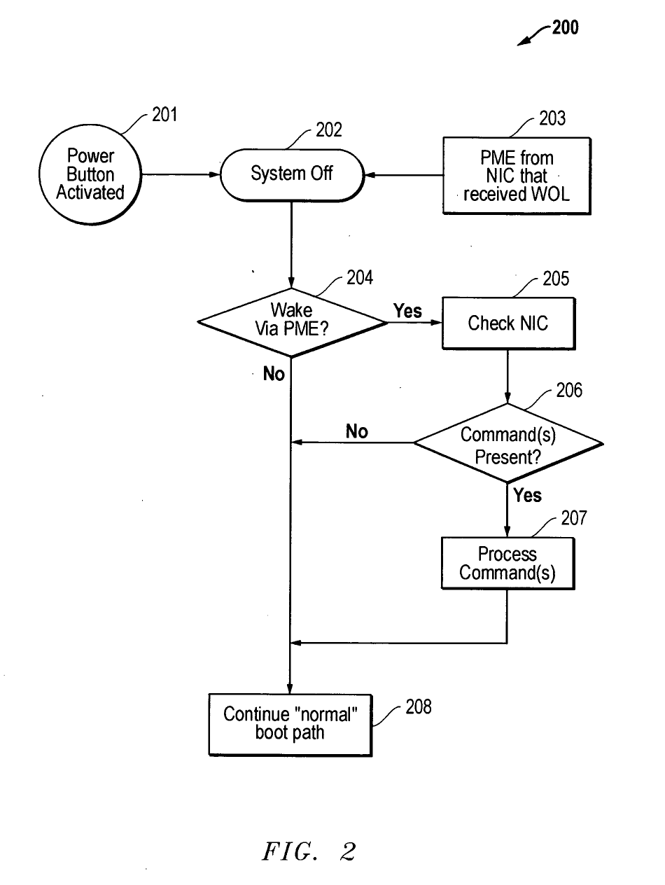

FIG. 2 is a flowchart showing the exemplary steps for a WOL information handling system startup process having one or more WOL instructions and control information for modifying the system startup process 200. It will be recognized that the flowchart shown in FIG. 2 is merely exemplary and the concepts described herein may be achieved through different or additional steps.

As shown in FIG. 2, while a system is powered off, step 202, the system can be turned on by activating a power button, step 201, or by another power management event (PME), such as a PME provided from a network interface card (NIC) that receives WOL data, step 203. In one embodiment, one or more WOL instructions are received, as well as control information for modifying the system startup process. The system control information provided as part of the WOL process may include any of the types of control information described above

At step 204 a determination is made regarding whether the system activation is the result of a PME or not. If NO, the normal boot path is continued, step 208. If YES, the NIC is checked at step 205 to obtain any system control information that has been provided as part of the WOL process. At step 206, a decision is made regarding whether system control information is present. If NO, the normal boot path is continued by proceeding to step 208. If YES, the control information is processed at step 207. In one embodiment, the processing at step 207 may include the use of a system or hard drive password, instructions bypassing any password requirements, an instruction to boot up from another device, an instruction to disable ASF reporting or any other system control commands provided as part of the WOL processing. Once the control information is processed at step 207, the normal boot path is continued by proceeding to step 208.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for performing a Wake On LAN (WOL) process for a network connected computer system, comprising:
receiving one or more WOL instructions; and
receiving control information as part of the WOL startup process for modifying the computer system startup process.

2. The method of claim 1, wherein the control information comprises a password.

3. The method of claim 2, wherein the password is a system boot password.

4. The method of claim 2, wherein the password is a hard drive password.

5. The method of claim 1, wherein the control information comprises instructions to startup a system by bypassing a password.

6. The method of claim 1, wherein the control information is stored in a network interface card (NIC).

7. The method of claim 1, wherein the control information is stored in a system memory resource.

8. The method of claim 1, wherein a WOL password is provided in addition to a password contained in the control information.

9. The method of claim 1, wherein the control information includes an instruction to boot up from another device.

10. The method of claim 9, wherein the other device is a network server.

11. The method of claim 1, wherein the control information includes instructions to disable Alert Standard Format (ASF) reporting.

12. The method of claim 1, further comprising reconfiguring a startup procedure of the computer system to modify a boot up sequence.

13. A method of controlling an information handling system, comprising:
providing Wake On LAN (WOL) functionality within the information handling system;
receiving WOL data; and
receiving a control signal in conjunction with the WOL data so as to cause a modified information handling system startup in response to the WOL data.

14. The method of claim 13, wherein the control information comprises a password.

15. The method of claim 14, wherein the password is a system password.

16. The method of claim 14, wherein the password is a hard drive password.

17. The method of claim 13, wherein the control information comprises instructions to startup the system by bypassing a password.

17. The method of claim 13, wherein the control information is stored in a network interface card (NIC).

18. The method of claim 17, wherein the control information stored in the network interface card (NIC) is sent to an alternate memory.

19. The method of claim 18, wherein a device receiving the WOL data anticipates a WOL password before completing the WOL process.

20. The method of claim 13, wherein the control information includes an instruction to boot up from another device.

21. The method of claim 20, wherein the other device is a network server.

22. The method of claim 13, wherein control information includes an instruction to disable Alert Standard Format (ASF) reporting.

23. An information handling system for implementing a Wake On LAN (WOL) computer system startup process, comprising:
a network interface that is configured to receive one or more WOL instructions; and
system BIOS that is configured to utilize control information provided as part of the WOL instructions for modifying the information handling system startup process.

24. The system of claim 23, wherein the network interface is a network interface card.

25. The system of claim 23, wherein the control information includes

26. The system of claim 23, wherein the control information comprises either a password or instructions to bypass a password requirement.

27. The system of claim 23, wherein the control information comprises an instruction to change a boot up device.
